(19) United States
(12) Patent Application Publication
(10) Pub. No.: US 2025/0375701 A1
(43) Pub. Date: Dec. 11, 2025

(54) LIVE TRIVIA GAME SYSTEM AND METHODS

(71) Applicants: Luis G Villanueva, III, Burbank, IL (US); Ronald J Larson, Alsip, IL (US)

(72) Inventors: Luis G Villanueva, III, Burbank, IL (US); Ronald J Larson, Alsip, IL (US)

(21) Appl. No.: 18/739,545

(22) Filed: Jun. 11, 2024

(51) Int. Cl. A63F 13/327; A63F 13/80; A63F 13/795; A63F 13/2145; A63F 13/798

(52) U.S. Cl. CPC A63F 13/327; A63F 13/80; A63F 13/795; A63F 13/2145; A63F 13/798

(57) ABSTRACT

A live trivia game system includes a networked computer system, presentation displays, and player mobile devices at a gathering place. A round of live trivia includes ten main questions and one bonus question, selected at random by the networked computer system. A category for the main questions is chosen by a thumb race, in which avatars representing different categories race across the presentation displays, driven by team captains tapping their thumbs on their player mobile device displays. Each team captain selects a preferred category before the thumb race, and the corresponding avatar is driven by that captain’s thumb taps and those of any other captain who preferred the same category. Conversely, the theme of the bonus question is chosen by team captains tapping on bubbles representing undesired categories to pop those bubbles. The bonus question is selected from the category represented by the last un-popped bubble.

### CROSS-REFERENCE

None.

### FIELD OF THE DISCLOSURE

The present disclosure relates to trivia games played using mobile devices. More particularly, it relates to a live trivia game played using mobile devices at a gathering location.

### BACKGROUND

There are some basic faults that are inherent in almost all live “barroom” trivia programs. First, trivia can be intimidating. Unless they are obsessed with the TV show Jeopardy, most customers in attendance will be discouraged by most of the questions, especially if multiple choice isn't an option. A second problem is cheating. Players will take their phones into the bathroom, or blatantly search out answers right at the table. This is more of a problem when an excessive amount of time is given to teams to discuss the answers. In some cases, a trivia host will share answers with friends that are in attendance, helping them win the prizes. Themed trivia, although very popular, will turn away customers that are unfamiliar with the selected subject. Weekly trivia players often become frustrated when the same team wins week after week. Some trivia companies mismanage their quizzes, which can allow teams to participate in quizzes that they have already seen, giving the team an unfair advantage. Some trivia nights use cumulative scoring. Teams must be signed up before the first question is asked. Anyone that shows up after the game begins is excluded from playing. Lastly, trivia as it is hosted today is slow paced and boring. After questions are asked teams huddle up and quietly discuss the answer, sometimes for an extended period. This often makes a bar as quiet as a library.

There is clearly a need for a barroom trivia game that is more accessible, fast-paced, and engaging than existing formats.

### SUMMARY

According to an aspect of the disclosure, a live trivia game system comprises a networked computer system, player mobile devices, a gathering place, an external network, and trivia game software executable by one or more of the networked computer system and the player mobile devices. The networked computer system comprises a server processor and a server memory. Each player mobile device comprises a mobile device processor, a mobile device memory, a mobile device display, and a mobile device input interface. A plurality of the player mobile devices are located at the gathering place. The networked computer system is operatively connected to the player mobile devices via the external network. The trivia game software comprises instructions for the networked computer system to register a plurality of player accounts, to define a plurality of teams, assign player accounts to each team, and enter the plurality of teams into a live trivia game session in response to requests transmitted from the mobile devices. The networked computer system memory stores a database of trivia questions, the database identifying, for each trivia question, all player accounts that have been presented that trivia question in a previous live trivia game session. The trivia game software comprises instructions for the networked computer system to select at random a plurality of trivia questions from a subset of trivia questions in the database that have not been presented to any player accounts assigned to a team entered in the current live trivia game session, and to present the selected trivia questions to the teams.

### BRIEF DESCRIPTION OF THE DRAWINGS

Although the characteristic features of this disclosure will be particularly pointed out in the claims, the disclosed method and system, and how it may be made and used, may be better understood by referring to the following description taken in connection with the accompanying drawings forming a part hereof, wherein like reference numerals refer to like parts throughout the several views and in which:

FIG. 1 is a simplified block diagram of a live trivia game system according to an embodiment.

FIGS. 2-14 are illustrative screenshots of a mobile app interface according to an embodiment.

FIG. 15 is a flow diagram illustrating a method of conducting a live trivia game according to an embodiment.

A person of ordinary skill in the art will appreciate that elements of the figures above are illustrated for simplicity and clarity and are not necessarily drawn to scale. The dimensions of some elements in the figures may have been exaggerated relative to other elements to help to understand the present teachings. Furthermore, a particular order in which certain elements, parts, components, modules, steps, actions, events and/or processes are described or illustrated may not be required. A person of ordinary skill in the art will appreciate that, for simplicity and clarity of illustration, some commonly known and well-understood elements that are useful and/or necessary in a commercially feasible embodiment may not be depicted to provide a clear view of various embodiments per the present teachings.

### DETAILED DESCRIPTION

In the following description of various examples of embodiments of the disclosed system and method, reference is made to the accompanying drawings, which form a part hereof, and in which are shown by way of illustration various example devices, systems, and environments in which aspects of the disclosed system and method can be practiced. Other specific arrangements of parts, example devices, systems, and environments, can be used, and structural modifications and functional modifications can be made without departing from the scope of the disclosed system and method.

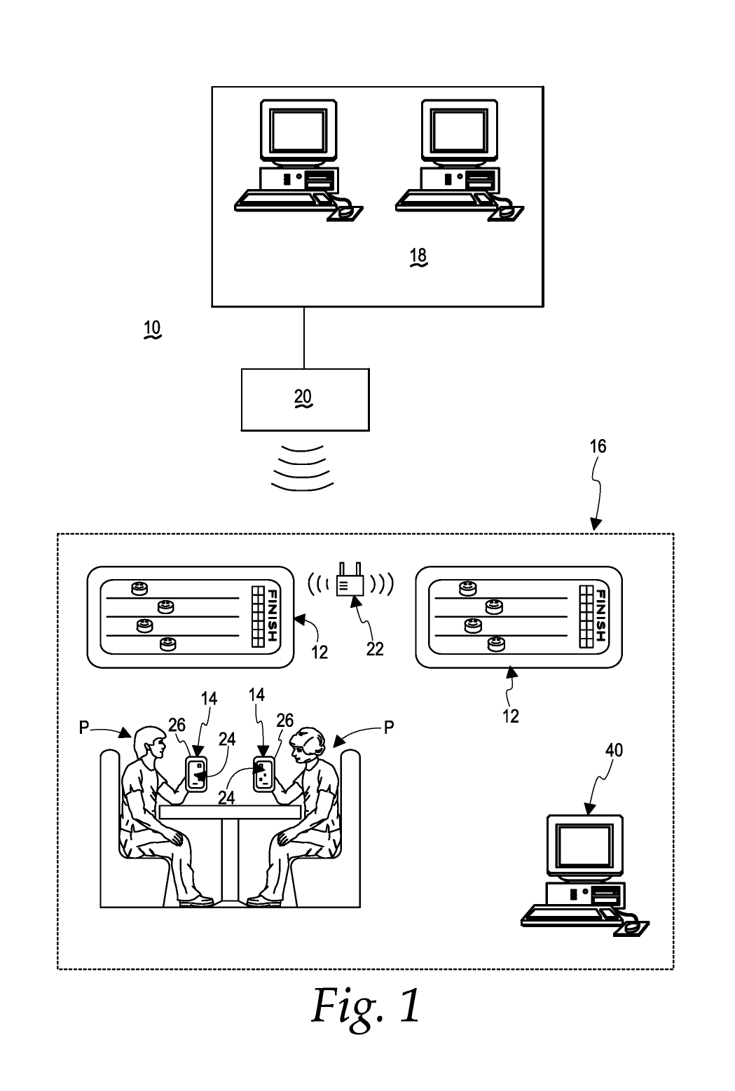

As illustrated in the accompanying drawings and described herein, the present disclosure provides a system and method to host and play an accessible, fast-paced, and engaging live trivia game in a gathering place, such as a pub, bar, restaurant, or other food venue. With reference to the simplified block diagram of FIG. 1, a live trivia game system 10 integrates electronic large-format presentation displays 12 (e.g., a television set, a computer monitor, or a video projector projecting images onto a screen, wall, or other viewing area at the gathering place 16) with game play on a mobile app running on player mobile devices 14 at a gathering place 16. The gathering place 16 typically comprises a suitable local area network (LAN) that is connected to a networked computer system 18 via an external network 20, such as the Internet. The player mobile devices 14 can for example comprise smartphones, smart watches, tablets, wearable computers, and/or other suitable devices which comprise a user input device, a display (a touchscreen display 26 typically serving as both an input device and a display), a microprocessor and memory, and a network adapter, so as to enable the device to perform the functions of a player mobile device 14 according to this disclosure. The computer system 18 comprises a microprocessor, memory, and a network adapter, so as to enable the computer system 18 to perform trivia game server functions according to this disclosure. The presentation displays 12 and, optionally, the player mobile devices 14 are connected to the LAN at the gathering place 16. For example, the presentation displays 12 can connect to a suitable router 22, such as via wi-fi or wired ethernet.

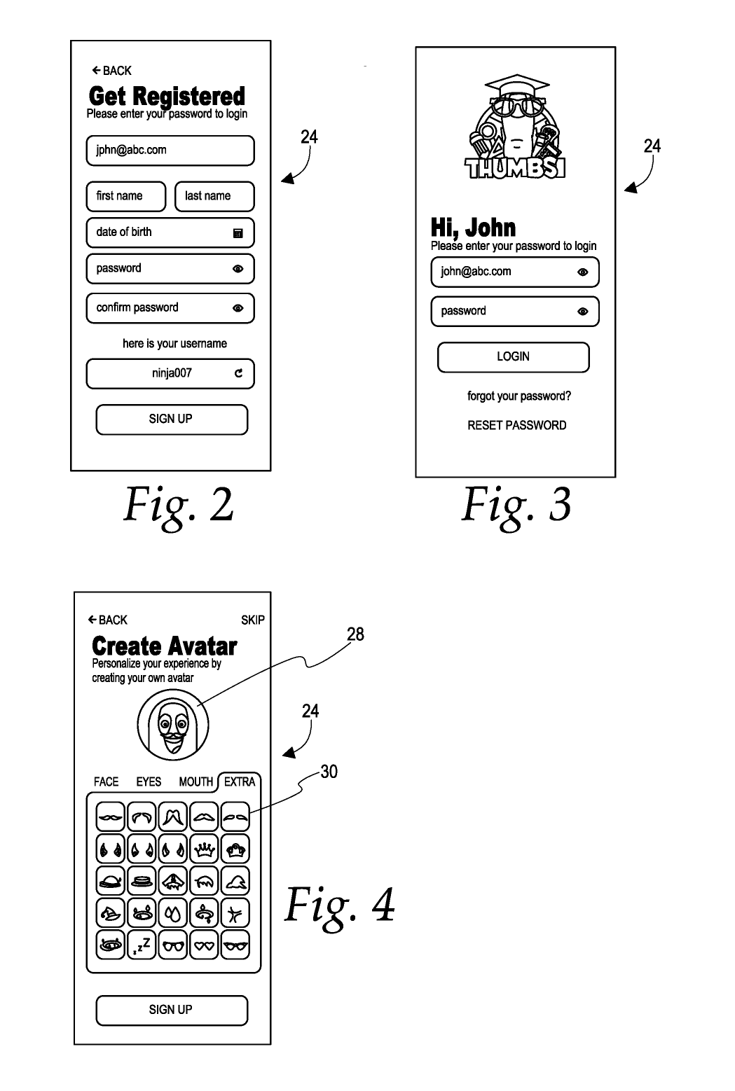

Players P register their own individual player profiles and create and manage teams using a mobile app interface 24 displayed on the touchscreen display 26 of the player mobile devices 14 running the mobile app. Representative screenshots of various views of the mobile app interface 24 are presented in FIGS. 2-14. As shown in the screenshot of FIG. 2, player registration information including a user ID/email address, name, date of birth, and password are input via the mobile app interface 24 to create a new user profile, to which a username is assigned. Shown in the screenshot of FIG. 3 is a portal for logging into the mobile app with the login credentials of the newly created user profile. As illustrated in the screenshot of FIG. 4, a user can create a user avatar 28 for their new user profile, applying selected face, eyes, mouth, and extra features from a features menu 30.

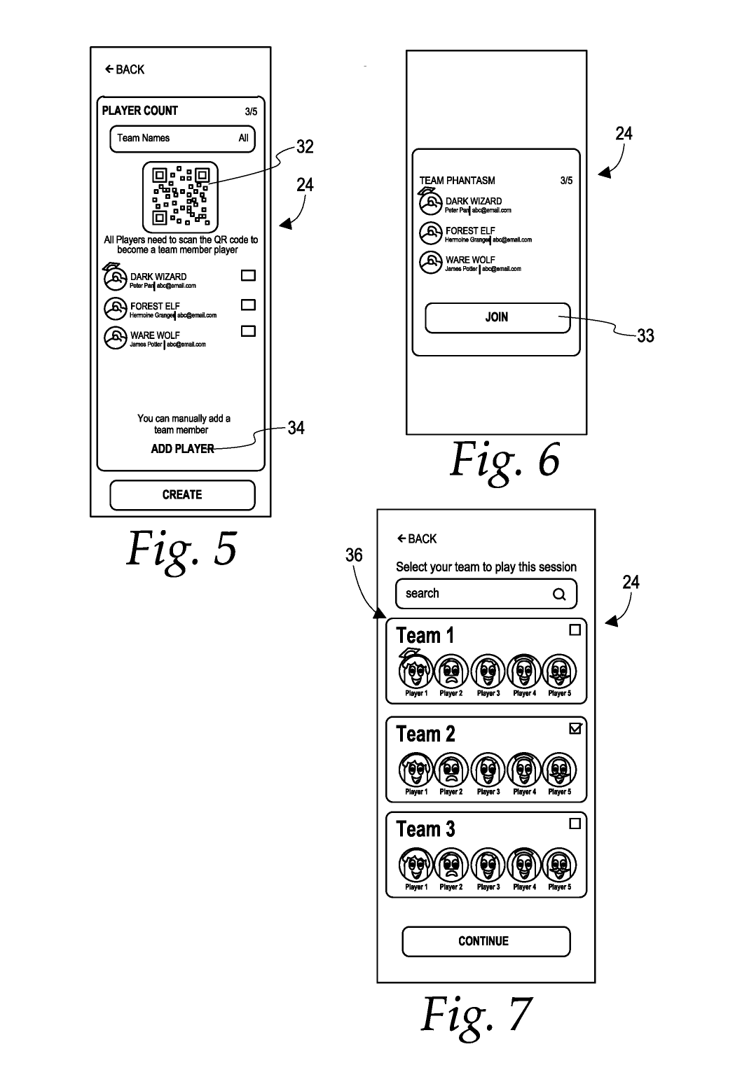

Illustrated in FIGS. 5-7 are screenshot views for the creation of a team and different ways to add players to a team. Shown in FIG. 5 is a screenshot of a team creation view of the mobile app interface 24, in which a player creating the team is prompted to enter a team name and add players to the team. A player can be added to the team by that player scanning a QR code 32 displayed in the team creation view of the player creating the team, either by activating a scanning function from within the mobile app while logged into their player account, or by using any suitable scanning utility of their player mobile device 14 to navigate to a URL for joining the team, followed by being prompted to log in to their account on the mobile app or enter their login at the URL to associate their username and player account with the team. The joining player may then be presented with a join screen as shown in FIG. 6, listing the team name and current team members and prompting the joining player to join the team by tapping a join control 33. Alternatively, the player creating the team can add a player to the team manually by tapping an add player control 34 and then searching for the player by username. The added player may then be prompted to accept an invitation (not shown) to join the team, or may be automatically added to the team. A third option to add a player to a team is illustrated in FIG. 7, a screen of the mobile app interface 24 prompting a player to select a team to join from a list 36 of available teams, which may for example comprise all teams of players currently connected to the LAN at the gathering place 16 and/or all teams that are entered to play in the next round to begin at the gathering place 16 and have at least one spot open for an additional player.

Trivia game server software running on the computer system 18 directs the computer system 18 to receive player input data from the player mobile devices 14, including player login credentials; team creation, naming and player selection data; and gameplay inputs; and to transmit live game content to the player mobile devices 14, including multiple-choice trivia questions and trivia categories for selection in action phases of the game to be described in more detail below. The trivia game server software also directs the computer system 18 to transmit public/common game views to be displayed on the presentation displays 12, such as views of the progress of a category-selection mascot race or a bubble stage as described below. Optionally, the presentation displays 12 can also display the currently pending question that has been presented to teams. In other embodiments, questions are not shown on the presentation displays 12, reducing the risk that a another patron who is not participating in the trivia game may blurt out an answer, which may influence the answer submitted by a participating team.

In the illustrated embodiment, each trivia question is presented with a multiple-choice set of answers, and teams select what they believe is the one correct answer. Answers are submitted on behalf of each team by just one player P, through that player’s mobile app interface 24. For ease of description, that player is referred to as the team “captain.” (In embodiments, any player from a team can be designated as that team’s representative for a particular phase of the game, and not necessarily the same player for each phase.) Other team members are only enabled to “vote” on answers by tapping a selected answer choice in the mobile app interface 24 on their respective touchscreen displays 26, causing an answer suggestion distribution 38 to appear on at least the captain’s interface 24, illustrated in FIGS. 12-14 as a number of teammate avatar icons appearing over a particular answer choice corresponding to the number of teammates suggesting that answer, if not appearing on each team member’s interface 24. In an embodiment, the answer suggestion distribution 38 is not displayed to any team member until each of the captain’s teammates has selected an answer suggestion (or run out of time to do so), so that the suggestion distribution 38 is revealed all at once to the team captain (and optionally to each teammate). Thus, the first answer suggestion chosen would not influence subsequent teammates’ choices. In another embodiment, the answer suggestion distribution 38 is displayed and updated in real time on each team member’s interface 24 as each of the captain’s teammates makes a selection. Optionally, players can be allowed to change their answer suggestion at any time while a question is pending. For example, a first teammate may initially choose an answer (A), while only slightly favoring (A) over another answer (B). Upon seeing most or all the other teammates choose (B), she may be persuaded that (B) is more likely the correct answer and change her selection to (B), thus presenting (B) to the captain as a stronger or unanimous favorite.

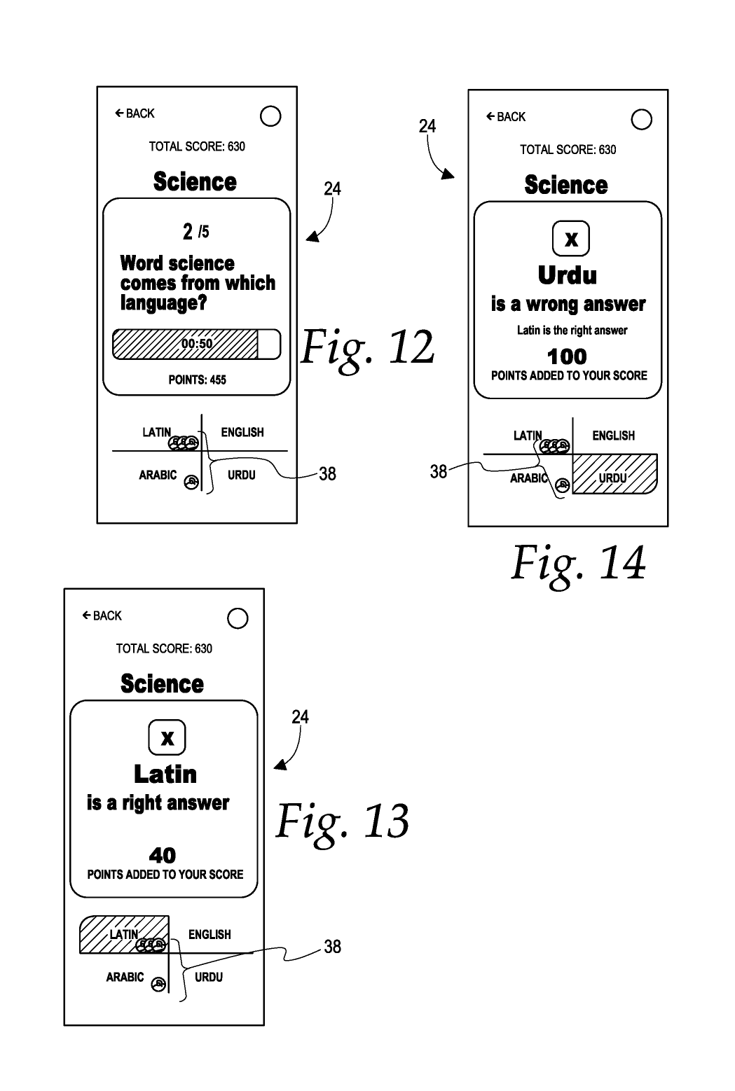

The live trivia game further incorporates certain elements to inhibit and/or discourage cheating and ensure no one is given an unfair advantage. In particular, cheating by using an internet search engine to look up answers is discouraged by time limits and time-variable scoring that does not allow adequate time, for example, for a player to duck into the bathroom to search the internet and then return with the correct answer. Thus, a clock starts after each question is presented, and teams must answer the question within a time limit, such as fifteen seconds. The score for each question is based on the exact amount of time it takes the team to submit a correct answer. For example, if it takes a team 5.73 seconds to answer correctly, the team’s score for that question will be proportional to 5.73. With a fifteen-second time limit, the highest possible score for a correct answer will be proportional to fifteen. An incorrect answer, or failure to submit any answer within the time limit, will be assigned a higher score than possible for any correct answer submitted within the time limit. Thus, in the examples illustrated in FIGS. 13 and 14, forty points are assigned for a correct answer while one hundred points are assigned for an incorrect answer. The team with the lowest score at the end of each game is the winner. To discourage cheating by collusion, even if the trivia game is hosted by a live person (a host may, for example, initiate a game using a live trivia game by logging into a host account on a host application running on a host computer 40 at the gathering place 16, announce the start of games/rounds, read questions aloud, provide entertaining commentary, present rules, etc.), questions are revealed to players P and the trivia host at the same time. Therefore, the host does not have the opportunity to share questions or answers with anyone beforehand. This security facilitates the offering of large cash jackpots. In addition, to avoid giving an unfair advantage to regular returning players, the software assigns each player a unique player number, and prior to presenting a question, it checks all player numbers to ensure that no one has seen the question before. To enhance security in game sessions offering very large cash prizes, player numbers can be associated with one or more forms of personal identification, such as a player’s driver’s license, state ID card, social security number or biometric features, so that a frequent player cannot play under multiple player numbers in the hope of being presented a question they have seen before under a different player number. In addition, each round taking a relatively short time to complete allows several rounds to be played in a given evening at a given gathering place 16. In conjunction with non-cumulative scoring and awarding of prizes for each round, this allows players who arrive at and leave the gathering place 16 at various times of the evening to enter one of the rounds and have a fair competitive chance of winning a prize.

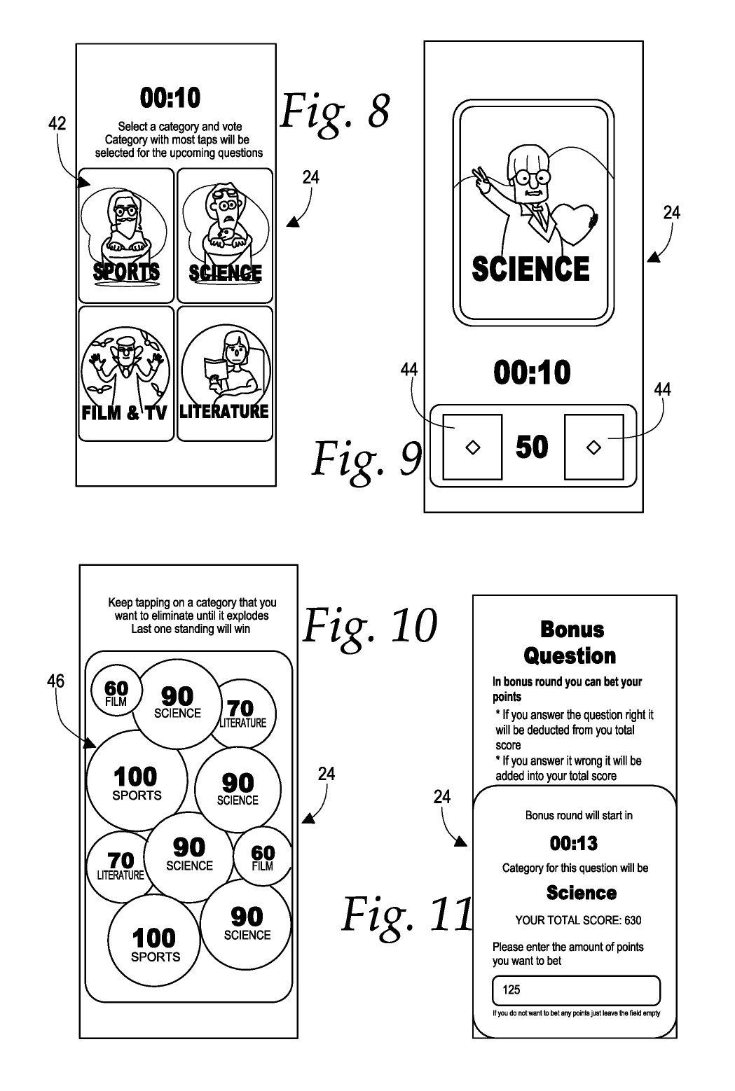

The themes or categories of trivia questions are chosen by the players in a fun and exciting manner as follows. Before a round of trivia starts, four randomly chosen categories 42 are displayed on the mobile app interface 24 of each team captain, as shown in FIG. 8, and optionally also on the presentation displays 12 of the gathering location 16 (not shown). Each basic category 42, such as science, literature, sports, and film & TV can be represented by an adorable mascot, such as an avatar in the shape of a thumb with human facial features, outfits, and other accessories. Teams will discuss which category would be best suited for them. As illustrated in FIG. 1, the four characters line up at the starting line of a race track shown on the presentation display 12, as a clock ticks down to signal the start of a race. Each team’s captain then uses both thumbs to alternately press two buttons 44 on their mobile app interface 24, shown in FIG. 9, as rapidly as they can. This will advance their chosen character along the racetrack displayed on the presentation display 12. The category represented by the character that crosses the finish line first will be the theme for the next five trivia questions. This race will repeat halfway through the round to choose a different category. Each round consists of ten questions, followed by a bonus question.

The bonus question also has a theme determined by a “bubble” phase. As illustrated in FIG. 10, possible bonus round themes are displayed inside floating bubbles 46 on each team captain’s mobile app interface 24 and on the presentation displays 12 (not shown) of the gathering place. Teams discuss which theme or themes they most prefer and which theme or themes they least prefer. When teams are ready the captain will start tapping bubbles 46 representing themes the team does not want. As illustrated, the themes include the same four main categories as for the main part of the round, Sports, Science, Literature, and Film & TV. In other embodiments, bonus question themes can be sub-categories of one of the main categories. For example, in the category Film & TV, the bonus question could relate to a sub-category such as a specific TV show, movie, singer, etc. After being tapped a certain number of times by the team captains collectively, a bubble 46 will pop. In embodiments, a bubble 46 may enlarge as it is tapped, as though swelling or inflating, each bubble 46 reaching a particular size before popping, so that the relatively inflated sizes of the bubbles 46 serve as a visual indicator of which bubbles 46 are closest to popping. As illustrated, a given theme may appear in more than one bubble 46, and some themes may appear in more bubbles 46 than other themes, so that eliminating a theme that initially appears in more bubbles 46 requires popping more bubbles 46. The theme of the last remaining un-popped bubble 46 will be the subject of the bonus question. Teams are able to wager a selected number of points on the bonus question, as illustrated in FIG. 11, based on their confidence in the selected sub-category, giving teams an opportunity to come from behind and win.

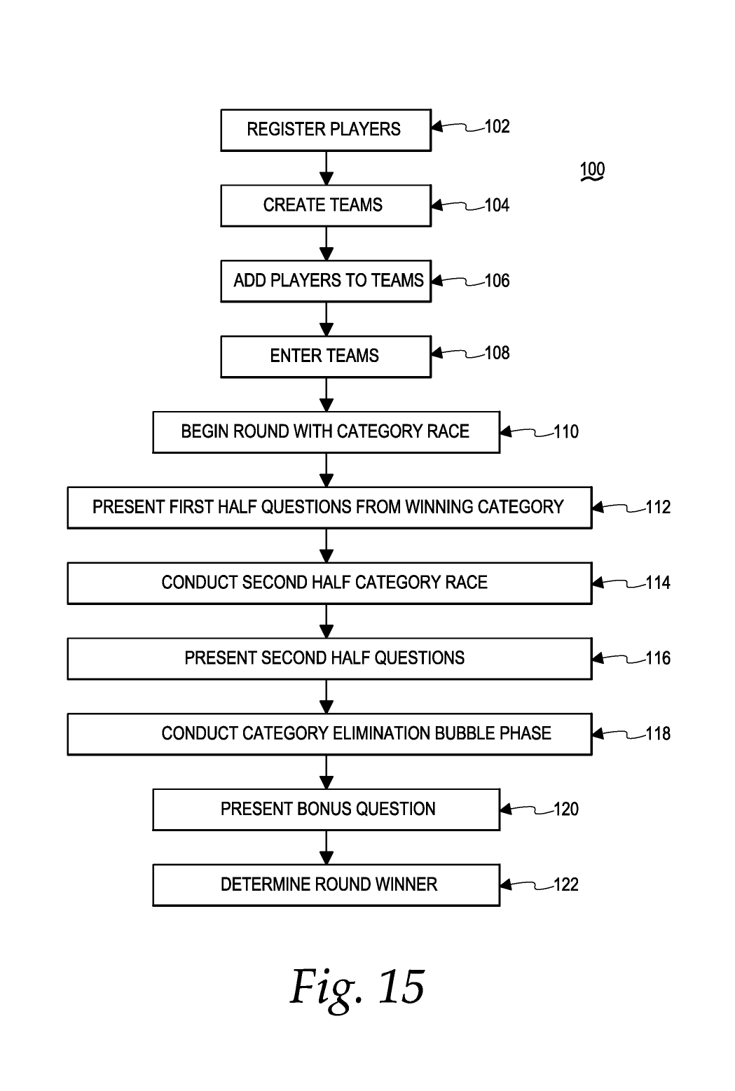

Presented in FIG. 15 is a flow diagram illustrating a method 100 of conducting a live trivia game using the live trivia game system 10. In a step 102, players are registered to the system 10 by the server application running on the networked computer system 18 receiving player registration data submitted from a player mobile device 14 running the mobile app, via the external network 20. In a step 104, teams are created by the server application receiving team creation data submitted by one of the registered players via the same channel. In a step 106, registered players are added to teams in one of the ways illustrated in FIGS. 5-7, and the computer system 18 receives and stores the team information. In a step 108, teams are entered into a live trivia game session to be conducted at the gathering place 16, by the networked computer system 18 receiving a request to enter the team, which may for example be transmitted directly from the team captain’s player mobile device 14 or via the host computer 40. For example, the host application may relay the request automatically to the networked computer system 18, or a host user of the host computer 40 may manually submit a request to the networked computer system 18 to enter selected teams that are registered on the host computer by the host application. Next, in a step 110, the round is initiated beginning with a category race, as shown and described above with reference to FIGS. 1, 8, and 9. In an embodiment, the category race can be conducted entirely on the LAN of the gathering place 16 by the host computer 40 receiving tap signals from captains’ player mobile devices 14 and updating the race progress shown on the presentation displays 12 accordingly, without interacting with the networked computer system 18, and without the risk of cheating by collusion, as no questions are presented in this step. In a step 112, the winning category from the category race is either communicated to the computer system 18 by the host computer 40, or if the category race was alternatively executed by the network computer system 18, determined directly by the computer system 18 receiving and counting the tap signals from the player mobile devices 14. The server application then selects and presents first-half questions for the round, randomly selected from a database of questions from the category that won the category race, avoiding any questions that are indicated in the memory of the computer system 18 as having been previously presented to any of the players on the participating teams. In addition, the server application directs the computer system 18 to store a record that each of the selected questions has now been presented to each player P on the participating teams, so that the questions will not be presented to any of those players P again. The questions are then presented to teams and answered by team captains on behalf of their teams, in view of suggestions from their teammates, as described above with reference to FIGS. 12-14.

Next, in a step 114, a second-half category race is initiated and conducted similarly to step 110 to determine the category for the second half of the main round questions. Then, in a step 116 the server application running on the computer system 18 selects and presents second-half questions for the round, randomly selected in a similar manner to the first-half questions, and for which a record is similarly created of the questions having been presented to the participants. Next, in a step 118, the category elimination bubble phase is conducted to determine the theme of a bonus question, in the manner described above with reference to FIG. 10. Similarly to the category races, the bubble phase can optionally be executed entirely locally on the LAN of the gathering place 16 without risk of allowing cheating or collusion, as no questions are presented in this phase. A winning theme emerges from the bubble phase, and teams choose an amount of points to wager for a question under that theme, as illustrated in FIG. 11, again optionally interacting only with the host computer 40 over the LAN of the gathering place 16. In a step 120, the server application randomly selects a bonus question from the winning theme of the bubble phase, which has not been previously seen by any participating player, and presents the question to the teams, whose captains submit their answers in view of answer suggestions selected by their teammates. Finally, in a step 122, teams are ranked from first place to last place in ascending order of their point totals for the round, and a prize or prizes is/are awarded accordingly.

The preceding description of the disclosure has been presented for purposes of illustration and description and is not intended to be exhaustive or to limit the disclosure to the precise form disclosed. The description was selected to best explain the principles of the present teachings and the practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification but be defined by the claim(s) set forth below. In addition, although narrow claims may be presented below, it should be recognized that the scope of this disclosure is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional disclosures are not dedicated to the public and the right to file one or more applications to claim such additional disclosures is reserved.

What is claimed is:

1. A live trivia game system comprising:
a networked computer system, the networked computer system comprising a server processor and a server memory;
player mobile devices, each player mobile device comprising a mobile device processor, a mobile device memory, and a mobile device display;
a gathering place, a plurality of the player mobile devices being located at the gathering place;
an external network; and
trivia game software executable by one or more of the networked computer system and the player mobile devices;
the networked computer system being operatively connected to the player mobile devices via the external network;
the trivia game software comprising instructions for the networked computer system to register a plurality of player accounts, to define a plurality of teams, assign player accounts to each team, and enter the plurality of teams into a live trivia game session in response to requests transmitted from the mobile devices;
the networked computer system memory storing a database of trivia questions, the database identifying, for each trivia question, all player accounts that have been presented that trivia question in a previous live trivia game session;
the trivia game software comprising instructions for the networked computer system to select at random a plurality of trivia questions from a subset of trivia questions in the database that have not been presented to any player accounts assigned to a team entered in the current live trivia game session, and to present the selected trivia questions to the teams.

2. The live trivia game system of claim 1, further comprising the trivia game software comprising instructions to present the selected trivia questions to the teams one at a time, to receive answers to the selected questions submitted by the teams, and, when a received answer is correct and submitted at a first elapsed time, to assign a first number of points to the answer, when a received answer is correct and submitted at a second elapsed time, the second elapsed time being greater than the first elapsed time and less than a prescribed time limit, to assign a second number of points to the answer, when the received answer is incorrect or submitted after the expiration of the prescribed time limit, to assign a third number of points to the answer, the first number of points being less than the second number of points, the second number of points being less than the third number of points, a winning team being a team to receive the least number of total points for the selected questions.

3. The live trivia game system of claim 1 wherein the database of trivia questions is subdivided into categories, further comprising the trivia game software comprising instructions to receive a player input selection of one of the categories preferred by each team from one of the team’s player accounts via a respective player mobile device, to receive repeated screen tap inputs to each respective player mobile device following the preferred category selection, to determine when a total number of screen tap inputs input into the respective player mobile devices, collectively, via which one of the categories was selected as the preferred category, first reaches a predefined threshold number, and to designate that category as a winning category, wherein the plurality of trivia questions selected at random by the networked computer system are selected from the winning category only.

4. The live trivia game system of claim 3, further comprising a presentation display located at the gathering place, the trivia game software comprising instructions to cause to be presented on the presentation display an image representing, for each category, said total number of screen tap inputs input into the respective player mobile devices, collectively, via which that category was selected as the preferred category.

5. The live trivia game system of claim 1, further comprising a presentation display located at the gathering place, wherein the database of trivia questions is subdivided into categories, further comprising the trivia game software comprising instructions to cause to be displayed on the presentation display and on a player mobile device of each team a plurality of objects, each displayed object representing one of the categories, to receive repeated screen tap inputs to the player mobile device of each team, each screen tap input being at the position of one of the objects, to eliminate each of the displayed objects for which a total number of screen tap inputs to said player mobile devices of the teams collectively reaches a threshold number, and to define as a winning category the category represented by a last remaining one of the displayed objects after all the other displayed objects are eliminated, further comprising instructions for the networked computer system to select a bonus question at random from a subset of trivia questions in the winning category that have not been presented to any player accounts assigned to a team entered in the current live trivia game session, and to present the selected bonus question to the teams.

6. The live trivia game system of claim 5 wherein the displayed objects are bubbles.

7. The live trivia game system of claim 6, further comprising the trivia game software comprising instructions to cause the displayed objects to appear to inflate as said screen tap inputs are received at their respective positions.

8. The live trivia game system of claim 4 wherein the presentation display is a display selected from the group consisting of a television set, a computer monitor, and a video projector.

9. The live trivia game system of claim 1 wherein the trivia game software further comprises instructions to receive for each team a designation of one of the player accounts as a team representative player account, to enable a team representative player logged into the team representative player account on one of the player mobile devices to submit an answer to each selected trivia question on behalf of the team, to display one of the selected trivia questions and a plurality of multiple choice answers to the selected trivia question on the player mobile device of the team representative player and on player mobile devices of each of the team representative’s teammates, to receive from each teammate a suggested answer input to the teammate’s player mobile device, and to display on the team representative’s mobile device a distribution of the teammates’ suggested answers.

10. The live trivia game system of claim 1 wherein the trivia game software comprises a player mobile app executable by each player mobile device and a server application executable by the networked computer system.
